(19) United States
(12) Patent Application Publication
(10) Pub. No.: US 2012/0096203 A1
(43) Pub. Date: Apr. 19, 2012

(54) Method and Apparatus for Realizing Remote Access of Terminal to USB Device

(75) Inventors: Zhiqin He, Shenzhen (CN); Guangping Hu, Santa Clara, CA (US); Fang Guan, Shenzhen (CN)

(73) Assignee: Huawei Device Co., LTD, Shenzhen (CN)

(21) Appl. No.: 13/340,066

(22) Filed: Dec. 29, 2011

Related U.S. Application Data
(63) Continuation of application No. PCT/CN09/73565, filed on Aug. 27, 2009.

(51) Int. Cl. G06F 13/00

(52) U.S. Cl. 710/110; 710/305

(57) ABSTRACT

An apparatus and method for realizing remote access to a Universal Serial Bus (USB) device are provided. The apparatus includes a USB Hub, an application processor, and a power adapter. The USB Hub is configured to receive a USB service access request sent by a remote terminal and forwarded by a wireless Internet data card, and to forward the USB service access request to the application processor. The application processor is configured to receive the USB service access request, to authenticate the remote terminal according to the USB service access request, and to permit the remote terminal to access a USB device connected to the USB Hub after the authentication is passed. The power adapter is configured to provide an operational power supply to the USB Hub and the application processor.

This application is a continuation of International Application No. PCT/CN2009/073565, filed on Aug. 27, 2009, which is hereby incorporated by reference in its entirety.

### TECHNICAL FIELD

The present invention relates to the field of wireless communications technologies, and more particularly to a method and an apparatus for realizing remote access of a terminal to a Universal Serial Bus (USB) device.

### BACKGROUND

With the development of wireless communications technologies, a USB Hub and Ethernet are combined in the conventional art to share a USB device in a home network. FIG. 1 is a view of a network topology in a home network in the conventional art. As shown in FIG. 1, a USB device in a home network is connected to a USB interface of a Network USB Hub, and the Network USB Hub is connected to a wireless router through an Ethernet interface. In this way, a terminal having a wireless Internet access function can, through wireless operations, access the USB device connected to the Network USB Hub at any position in a home cell, without connecting the USB device to the terminal.

The USB Hub in the conventional art, however, can only realize the access of a terminal of a private network such as a home network to a USB device in the private network, but cannot realize the remote access of a terminal of a wide area network to a USB device in a certain home network, thereby limiting the access range of the terminal to the USB device.

### SUMMARY OF THE INVENTION

The embodiments of the present invention are directed to a method and an apparatus for realizing remote access of a terminal to a USB device, so as to realize wireless access of a remote user to a USB device in a local area network.

In an embodiment, the present invention provides an apparatus for realizing remote access to a USB device, which includes: a USB Hub, an application processor, and a power adapter. The USB Hub is configured to forward a USB service access request to the application processor after receiving the USB service access request sent by a remote terminal and forwarded by a wireless Internet data card; the application processor is configured to receive the USB service access request, and authenticate the remote terminal according to the USB service access request, and permit the remote terminal to access a USB device connected to the USB Hub after the authentication is passed; and the power adapter is configured to provide an operational power supply to the USB Hub and the application processor.

In an embodiment, the present invention provides a method for realizing remote access to a USB device. The method includes: receiving a USB service access request sent by a remote terminal and forwarded by a wireless Internet data card; authenticating the remote terminal according to the USB service access request; and permitting the remote terminal to access a USB device connected to a USB Hub after the authentication is passed.

It can be seen from the above embodiments that, a novel device and method for remote access to a USB device through a wireless broadband network are provided for the remote terminal on the basis of the wireless Internet data card, to enable the remote terminal to access a USB device in any place at any time. Therefore, the access range of not greater than 100 meters around the home in the conventional art has been expanded to the entire world according to the above embodiments. That is, the access range of a terminal to a USB device is expanded.

### BRIEF DESCRIPTION OF THE DRAWINGS

To make the technical solution under the present invention clearer, the accompanying drawings for illustrating the embodiments of the present invention or the conventional art are outlined below. The accompanying drawings are for the exemplary purpose only, and person having ordinary skill in the art can derive other drawings from such accompanying drawings without any creative effort.

FIG. 1 is a view of a network topology in a home network in the conventional art;

FIG. 2 is a structural view of an embodiment of an apparatus for realizing remote access of a terminal to a USB device according to the present invention;

FIG. 3 is an architectural view of a system for realizing remote access of a terminal to a USB device according to the present invention;

FIG. 4 is a flow chart of an embodiment of a method for realizing remote access of a terminal to a USB device according to the present invention; and

FIG. 5 is a schematic diagram of a data flow of access of a remote terminal to a USB device according to the present invention.

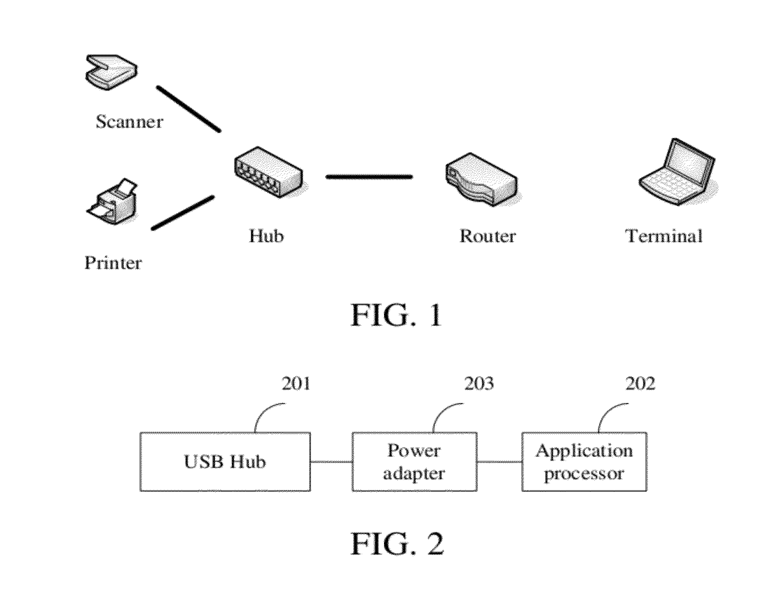

### DETAILED DESCRIPTION OF ILLUSTRATIVE EMBODIMENTS

To make the objectives, technical solution and merits of the present invention clearer, a detailed description of the present invention is hereinafter provided with reference to the accompanying drawings.

### Embodiment 1

FIG. 2 is a structural view of an apparatus for realizing remote access of a terminal to a USB device according to the present invention. Referring to FIG. 2, the apparatus includes a Universal Serial Bus USB Hub 201, an application processor 202, and a power adapter 203. The components of the apparatus and connection relationships between the components are further described below with reference to the working principle of the apparatus.

The USB Hub 201 is configured to forward a USB service access request to the application processor 202 after receiving the USB service access request sent by a remote terminal and forwarded by a wireless Internet data card.

The application processor 202 is configured to receive the USB service access request, and authenticate the remote terminal according to the USB service access request, and permit the remote terminal to access a USB device connected to the USB Hub 203 after the authentication is passed.

The power adapter 203 is configured to provide an operational power supply to the USB Hub 201 and the application processor 202.

The USB Hub 201 includes a USB Slave interface and a USB Master interface. The USB Master interface is connected to the wireless Internet data card, and the USB Slave interface is connected to the application processor 202.

The wireless Internet data card includes a radio frequency interface and a USB Master interface. The radio frequency interface is connected to a high gain antenna, and the USB Master interface is connected to the USB Hub 203.

The application processor 202 includes a USB Slave interface and a USB Master interface. The USB Master interface is connected to the USB Hub 203 and is set with a public network Internet Protocol (IP) address, and is configured to interact with a broadband wireless network side through the USB Hub by using the public network IP address. The USB Slave interface is connected to a local terminal and is set with a private network IP address, and is configured to interact with the local terminal by using the private network IP address and a Universal Plug and Play (UPnP) protocol.

Further, the apparatus also includes a rechargeable battery, configured to automatically charge when an external power supply is provided to the apparatus, and provide power to the apparatus when the external power supply is cut off.

Therefore, for a local personal computer (PC), the apparatus is not only a network card device, but also a network service device. For a user of the local PC, using experience is the same as that when the user accesses the USB device of the apparatus through a wireless broadband network. When the user of the local PC accesses a wireless broadband network, network address translation (NAT) is required between the USB private network and the wireless broadband network, so as to realize access of the local PC to a service of a mobile Internet through the wireless Internet data card.

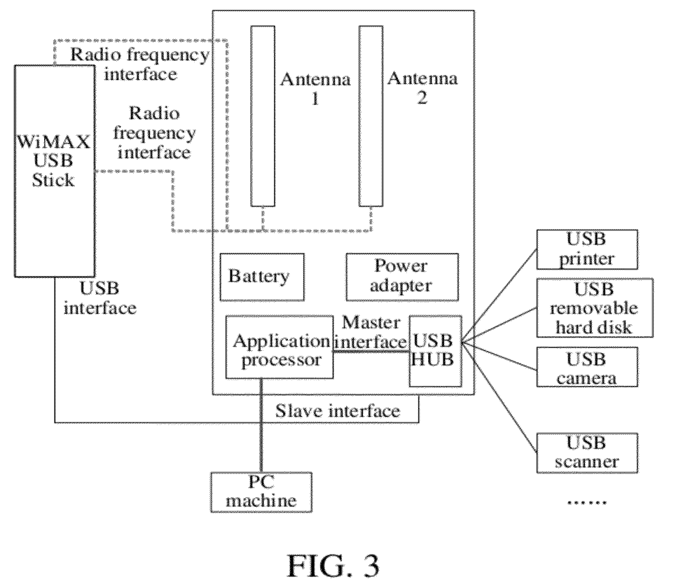

For example, FIG. 3 is a hardware architectural view of a system according to Embodiment 1 of the present invention. The system mainly includes six parts: an application processor, a battery, a power adapter, two high gain antennas, a USB Hub component, and a WiMAX USB Stick, where the application processor includes a USB Master interface and a USB Slave interface. The battery automatically charges when an external power supply is provided to the system and provides power to the system when the external power supply is cut off. The USB Master interface of the application processor is connected to a USB Hub component, the USB Hub component provides a plurality of USB interfaces to the outside and is connected to a plurality of USB devices, and the USB Slave interface of the application processor is connected to a local PC, to enable a user of the local PC to not only remotely access the USB device by connecting to a wireless Internet through the USB Slave interface, but also access various local USB devices. The WiMAX USB Stick includes radio frequency interfaces and a USB interface, and the WiMAX USB Stick is connected to the USB Hub component through the USB interface. Meanwhile, two radio frequency interfaces of the WiMAX USB Stick are separately connected to two high gain antennas, so that the WiMAX USB Stick receives, by means of the two high gain antennas, access requests for accessing the USB devices in the system, where the access requests are sent by a remote terminal having a wireless Internet access function through the wireless Internet.

It can be seen from the above embodiment that, a novel device and method for remote access to a USB device through a wireless broadband network are provided for the remote terminal on the basis of the wireless Internet data card, to enable the remote terminal to access a USB device in any place at any time. Therefore, the access range of not greater than 100 m around the home in the conventional art is expanded to the entire world. That is, the access range of the terminal to the USB device is expanded.

Moreover, in the embodiment of the present invention, because the wireless Internet data card is connected to the USB Hub through the USB interface, power is saved and resources are reserved.

### Embodiment 2

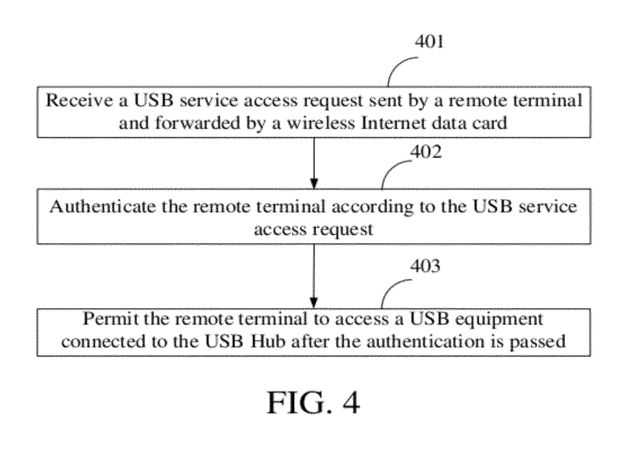

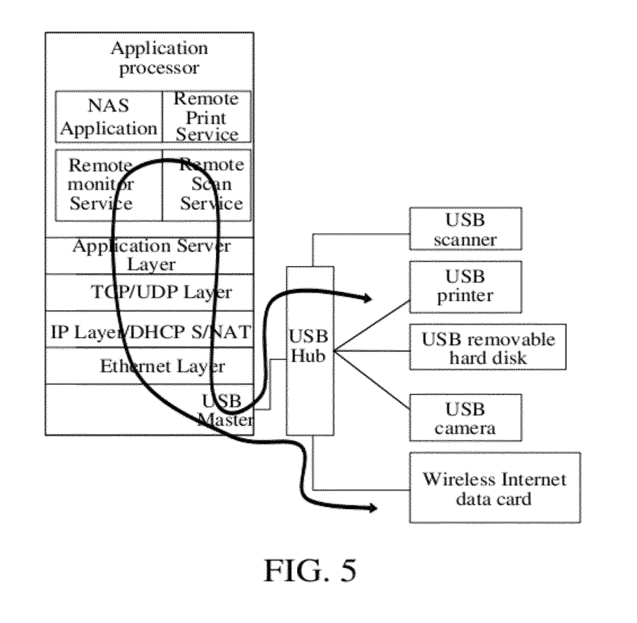

FIG. 4 is a flow chart of an embodiment of a method for realizing remote access of a terminal to a USB device according to the present invention. The method for realizing remote access of a terminal to a USB device is described in detail below. Referring to FIG. 4, the method includes the following steps.

Step 401: Receive a USB service access request sent by a remote terminal and forwarded by a wireless Internet data card.

The service access request is received and forwarded by the wireless Internet data card through a high gain antenna.

Step 402: Authenticate the remote terminal according to the USB service access request.

The step of permitting the remote terminal to access the USB device connected to the USB Hub includes sending a USB service list to the remote terminal, receiving a service request sent by the remote terminal according to the USB service list, identifying a type of the service in the service request, and performing service processing corresponding to the type of the service.

Step 403: Permit the remote terminal to access a USB device connected to a USB

Hub after the authentication is passed.

For example, after the authentication of the application processor is passed, and the remote terminal is permitted to access the USB device connected to the USB Hub, a data flow processing procedure of the access of the remote terminal to the USB device is as shown in FIG.

5, which is a schematic diagram of a data flow of the access of the remote terminal to the USB device. A data flow of the remote access of the remote terminal to the USB device through a wireless broadband network starts from the wireless Internet data card, passes through the USB Hub and arrives at the application processor, and then arrives at an application layer after the processing of a TCP/IP protocol stack, and a type of the service is identified by protocol parsing. According to various types of USB device, the types of the service generally include a remote monitoring service, a remote printing service, a remote access service, and a remote scanning service. After the type of the service is identified, a processing module is invoked according to the type of the service, and performs service processing corresponding to the type of the service. By taking an NAS Application module as an example, after it is identified that the type of the service is a remote access service, the NAS Application module accesses data in a USB removable hard disk, and then returns the data to the remote terminal through the WiMAX USB Stick.

It should be further noted that, the present invention imposes no limitation on the type of the wireless Internet, which may be Worldwide Interoperability for Microwave Access (WiMAX), Wideband Code Division Multiple Access (WCDMA), Code Division Multiple Access (CDMA), High Speed Packet Access (HSPA), HSPA+, or Time Division-Synchronous Code Division Multiple Access (TD-SCDMA).

It can be seen from the above embodiment that, a novel device and method for remote access to a USB device through a wireless broadband network are provided for the remote terminal on the basis of the wireless Internet data card, to enable the remote terminal to access a USB device in any place at any time. Therefore, the access range of not greater than 100 meters around the home in the conventional art is expanded to the entire world. That is, the access range of the terminal to the USB device is expanded.

Moreover, in the embodiment of the present invention, because the wireless Internet data card is connected to the USB Hub through the USB interface, power is saved and resources are reserved.

Persons of ordinary skill in the art may understand that all or part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be a magnetic disk, a Compact Disk Read-Only Memory (CD-ROM), a Read-Only Memory (ROM), or a Random Access Memory (RAM).

A method and device for realizing remote access of a terminal to a USB device provided by the present invention are described in detail above, the principle and implementation of the present invention are described herein through specific embodiments, and the description of the embodiments are merely intended to make the method and core idea of the present invention comprehensible. Person having ordinary skill in the art can make variations and modifications to the present invention in terms of the specific implementations and application scopes according to the ideas of the present invention. Therefore, the specification shall not be construed as limitations to the present invention.

What is claimed is:

1. An apparatus for realizing remote access to a Universal Serial Bus (USB) device, the apparatus comprising:
a USB Hub;
an application processor; and
a power adapter,
wherein the USB Hub is configured to forward a USB service access request to the application processor after receiving the USB service access request sent by a remote terminal and forwarded by a wireless Internet data card;
wherein the application processor is configured to receive the USB service access request, to authenticate the remote terminal according to the USB service access request, and to permit the remote terminal to access a USB device connected to the USB Hub after the authentication is passed; and
wherein the power adapter is configured to provide an operational power supply to the USB Hub and the application processor.

2. The apparatus according to claim 1, wherein the USB Hub comprises a USB Slave interface and a USB Master interface, the USB Master interface being connected to the wireless Internet data card and the USB Slave interface being connected to the application processor.

3. The apparatus according to claim 2, wherein the wireless Internet data card comprises a radio frequency interface and a USB Master interface, the radio frequency interface being connected to a high gain antenna and the USB Master interface being connected to the USB Hub.

4. The apparatus according to claim 1, wherein the application processor comprises a USB Slave interface and a USB Master interface,
wherein the USB Master interface is connected to the USB Hub and is set with a public network Internet Protocol (IP) address, and is configured to interact with a broadband wireless network side through the USB Hub by using the public network IP address; and
wherein the USB Slave interface is connected to a local terminal and is set with a private network IP address, and is configured to interact with the local terminal by using the private network IP address and a Universal Plug and Play (UPnP) protocol.

5. The apparatus according to claim 1, further comprising:
a rechargeable battery, configured to automatically charge when an external power supply is provided to the apparatus, and to provide power to the apparatus when the external power supply is cut off.

6. A method for realizing remote access to a Universal Serial Bus (USB) device, the method comprising:
receiving, by an application processor, a USB service access request sent by a remote terminal and forwarded by a wireless Internet data card;
authenticating, by the application processor, the remote terminal according to the USB service access request; and
permitting, by the application processor, the remote terminal to access a USB device connected to a USB Hub after the authentication is passed.

7. The method according to claim 6, wherein the service access request is received and forwarded by the wireless Internet data card through a high gain antenna.

8. The method according to claim 6, wherein permitting the remote terminal to access the USB device connected to the USB Hub comprises:
sending a USB service list to the remote terminal;
receiving a service request sent by the remote terminal according to the USB service list;
identifying a type of the service in the service request; and
performing service processing corresponding to the type of the service.
